(19) United States
(12) Patent Application Publication
(10) Pub. No.: US 2012/0159351 A1
(43) Pub. Date: Jun. 21, 2012

(54) MULTIPLE REVIEWS OF GRAPHICAL USER INTERFACES

(75) Inventors: Denise A. Bell, Austin, TX (US); David A. Budreau, Innisfil (CA); Travis M. Grigsby, Austin, TX (US); Jana H. Jenkins, Raleigh, NC (US)

(73) Assignee: International Business Machines Corporation, Armonk, NY (US)

(21) Appl. No.: 12/974,236

(22) Filed: Dec. 21, 2010

(51) Int. Cl. G06F 3/048; G06F 3/01

(52) U.S. Cl. 715/753; 715/763

(57) ABSTRACT

Embodiments includes a method comprising generating a User Interface (UI) application, based on instructions from a developer using a software development tool. The UI application includes an edit layer configured to enable multiple reviewers of the UI application to graphically overlay multiple reviews of the UI application over a display of the UI application, wherein the multiple reviews comprise a markup of at least one of a design, a layout and a wording of text of the UI application. The method also includes receiving the multiple reviews of the UI application from the multiple reviewers. The method includes displaying, for review by the developer, the UI application and the multiple reviews graphically overlaid on the UI application.

### BACKGROUND

Embodiments of the inventive subject matter generally relate to the field of computers, and, more particularly, to multiple reviews of Graphical User Interfaces (GUIs).

The process of developing a GUI can be intense and complex. Many different people can contribute to the design, layout, content, terminology, etc. as the interface develops. As part of the development process, there are periodic reviews where persons from different development perspectives can contribute, make comments, suggestions and changes, etc.

### SUMMARY

Embodiments includes a method comprising generating a User Interface (UI) application, based on instructions from a developer using a software development tool. The UI application includes an edit layer configured to enable multiple reviewers of the UI application to graphically overlay multiple reviews of the UI application over a display of the UI application, wherein the multiple reviews comprise a markup of at least one of a design, a layout and a wording of text of the UI application. The method also includes receiving the multiple reviews of the UI application from the multiple reviewers. The method includes displaying, for review by the developer, the UI application and the multiple reviews graphically overlaid on the UI application.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a conceptual diagram of a system to enable multiple reviews of a Graphical User Interface (GUI), according to some example embodiments.

FIG. 2 depicts an example GUI prior to addition of reviews of the GUI, according to some example embodiments.

FIG. 3 depicts the example GUI of FIG. 2 wherein an edit layer for adding reviews of the GUI, according to some example embodiments.

FIG. 4 depicts the example GUI of FIG. 3 wherein a review has been added using the edit layer, according to some example embodiments.

FIG. 5 depicts the example GUI of FIG. 4 wherein a response to the review has been added using the edit layer, according to some example embodiments.

FIG. 6 depicts a different example GUI prior to addition of reviews of the GUI, according to some example embodiments.

FIG. 7 depicts the example GUI of FIG. 6 after the addition of multiple reviews, according to some example embodiments.

FIG. 8 depicts a flowchart for creating and outputting a GUI for enable multiple reviews of the GUI, according to some example embodiments.

FIG. 9 depicts a flowchart for providing a review of multiple reviews of a GUI, according to some example embodiments.

FIG. 10 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to use relative to a User Interface (UI) application output from a developer tool, some other example embodiments can be applicable to any type of UI application. For example, some example embodiments are applicable to review of content being displayed on various applications (word processing applications, presentation applications, spreadsheet applications, etc.) by multiple reviewers. In other instances, well-known instruction instances, protocols, structures and techniques have not been shown in detail in order not to obfuscate the description.

Some example embodiments provide a system and method to provide reviews (e.g., comments, suggestions, changes, etc.) to a User Interface (UI) (e.g., Graphical User Interface (GUI)) being developed, such that these reviews are built into the development stream. In conventional systems, the different facets of development of a UI and reviews by various reviewers of the UI are manual activities. For example, persons are in a meeting reviewing the UI and are discussing various comments and suggestions regarding the UI. One of the persons at the meeting is taking notes about the different comments and suggestions. Alternatively, various electronic communications (e.g., email, instant messaging, etc.) are exchanged among the developers and reviewers. Reviewers of a UI can include designers and writers of the UI, other developers of the same or different UI, testers of the UI, persons in marketing or sales related to the UI, management, etc.

Some example embodiments incorporate an edit layer for the UI that is integrated into the development stream. In some example embodiments, this edit layer is consistent with standard development methods. This edit layer is created so that the reviewer can mark up the design, layout, words, etc. using shapes, proofreaders' marks, etc. Accordingly, the development process can be more efficient. The developers can simply turn on these edit layers for the UI before sending the UI to the appropriate reviewers. The reviewers can save and return the edit layer for implementation and disposition of the comments and suggestions.

In some example embodiments, as part of the build of the UI application, a developer can activate an edit layer. For example, the developer can activate the edit layer in some type of configuration file for the UI application. The edit layer can be a GUI container that has some editing controls. Accordingly, when the UI application is built, the edit layer can be used instead of normal UI containers. The edit layer can be implemented using any type of applications that enables the reviews to be integrated with the visual output of the UI application. Example applications that can implement the edit layer include Standard Widget Toolkit (SWT) shell, HyperText Markup Language (HTML) DIV, etc. The edit layer includes controls to add a general comment, add a comment to a particular spot in the UI application, draw a figure, screen capture, motion capture, Document Object Model (DOM) selections for more precise commenting, audio notes, etc.

After the build of the application, different reviewers can use tools within a edit layer of the UI application to add reviews (e.g., comments, suggestions, etc.) to the UI application. For example, using tools within the edit layer, the different reviewers can add markup ink, callouts, text overlays, etc. to the UI application. Accordingly, the multiple reviews from multiple reviewers can be viewable on the UI application. In some example embodiments, the multiple reviews by the multiple reviewers are stored in review folders that are stored with the UI application. Alternatively or in addition, the multiple reviews can be stored in a persistent storage on a backend server, on the developer device, etc. The edit layer can be communicatively coupled to the persistent storage to store the review folders therein. The reviews can be stored in different formats. For example, the reviews can be stored as images, as markup (e.g., Extensible Markup Language (XML) with screen coordinates, control names, etc.), as attributes in source code for particular DOM elements (which can be added on developer side rather than on the review side), etc. The reviews can be stored with different types of metadata. Examples of the different types of metadata include the reviewer name, review date, reviewer discipline (e.g., designer, tester, marketing person, etc.), UI application identification, etc. The UI application identification can include any type of identifier to differentiate among different version of the code (e.g., hash, version number, etc.). The multiple reviewers can subsequently transmit (e.g., email) the review folders to the developer. Alternatively or in addition, the reviewers can return the reviews to the developer by providing some indication in the review layer that the review is complete (e.g., button selection in the review layer being displayed). Some application associated with the persistent store can notify the developer of the completion of the review.

The developer can receive the review folders and stored these folders in an application directory on their own computer, device, etc. Alternatively or in addition, the developer can select an import option (e.g., button selection) in the review layer to extract the reviews from the persistent store. Accordingly, after the developer opens the UI application, the review layer loads the reviews from the review folders into the UI application. Thus, the developer can view the different reviews from the different reviewers on the UI application being displayed. In some example embodiments, the developer can filter the reviews based on reviewer names, date, reviewer discipline, application version, etc. Also, the developer can progressively disclose the reviews. For example, the developer can progressively disclose metadata or more detailed information on a particular review. In some example embodiments, the developer can click through reviews from different reviewers and have the reviews displayed on the UI application.

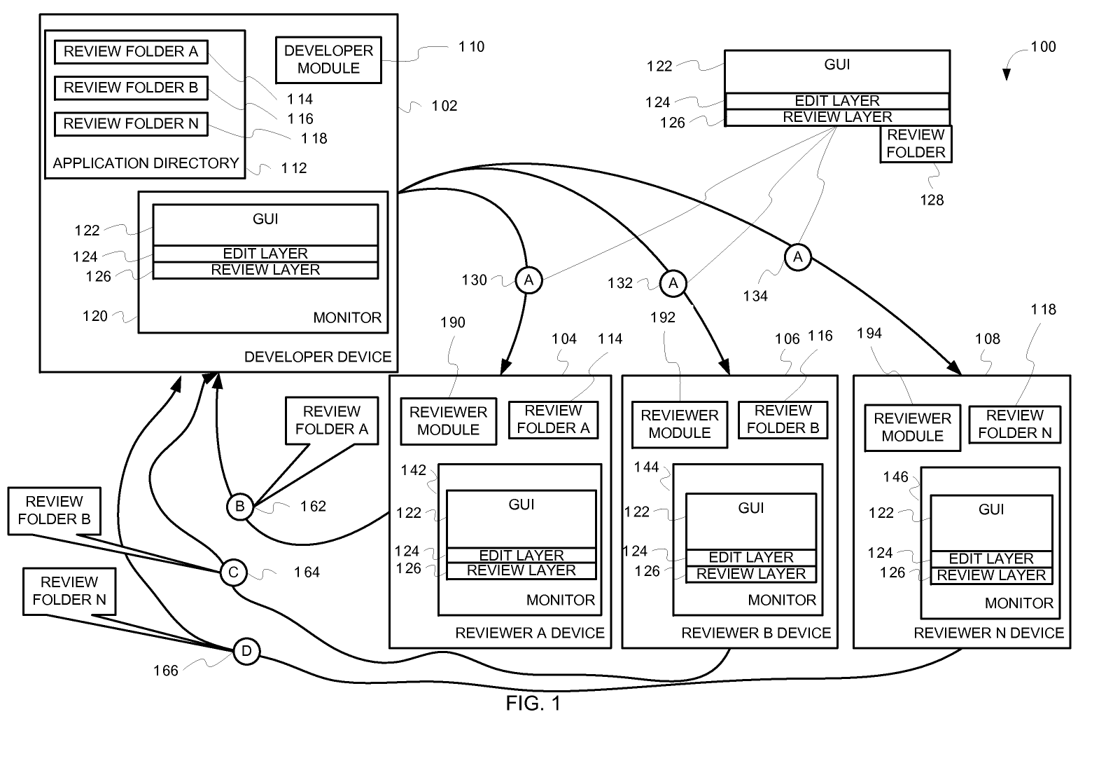

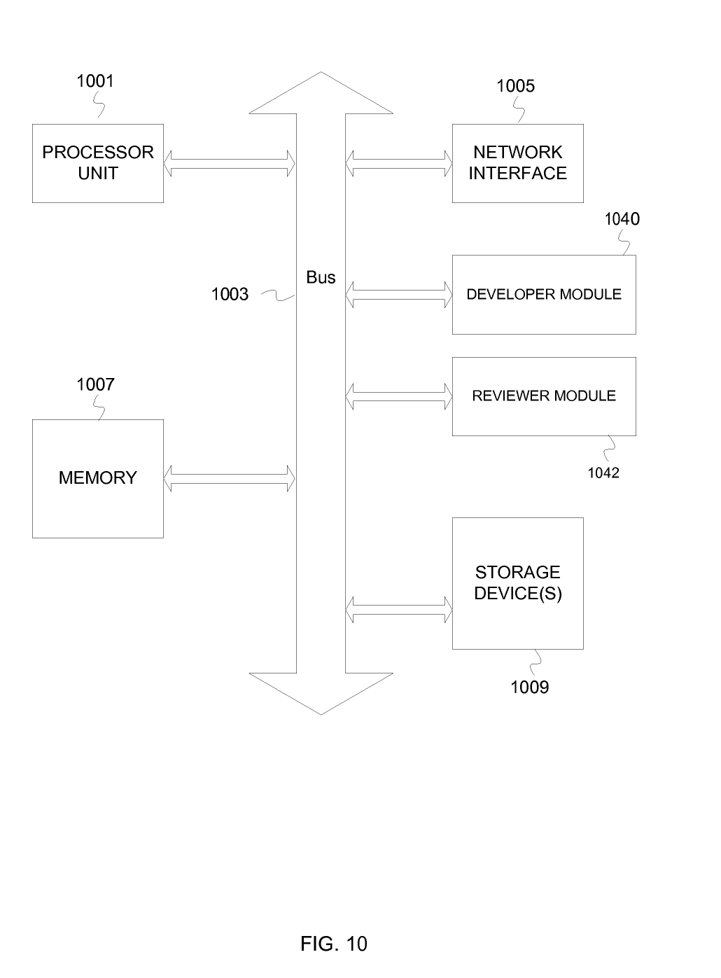

FIG. 1 depicts a conceptual diagram of a system to enable multiple reviews of a Graphical User Interface (GUI), according to some example embodiments. FIG. 1 depicts a system 100 that includes a developer device 102, a reviewer A device 104, a reviewer B device 106, and a reviewer N device 108 that are communicatively coupled together. For example, the developer device 102, the reviewer A device 104, the reviewer B device 106, and the reviewer N device 108 that are communicatively coupled together through any type of network. The developer device 102, the reviewer A device 104, the reviewer B device 106, and the reviewer N device 108 can be any type of computer or computing device to perform the operations as described herein. An example computer that can be representative of any one of the developer device 102, the reviewer A device 104, the reviewer B device 106, and the reviewer N device 108 is described below in reference to FIG. 10. The developer device 102 is used by a developer of a UI application (a GUI 122). The reviewer A device 104 is used by a reviewer A to review the GUI 122. The reviewer B device 106 is used by a reviewer B to review the GUI 122. The reviewer N device 108 is used by a reviewer N to review the GUI 122. There can be any number of reviewers reviewing the GUI 122. The reviewers can include designers and writers of the GUI, other developers of the same or different GUI, testers of the GUI, persons in marketing or sales related to the GUI, management, etc.

The developer can use a developer module 110 to develop the code that creates the GUI 122. The developer can also use the developer module 110 to build or create the GUI 122 based on the developed code. The developer module 110 can be representative of software, firmware, hardware or a combination thereof that enables a developer to develop UI applications. Examples of the developer module 110 include Adobe® Dreamweaver®, WebDev, Microsoft® Expression Studio, different types of HTML editors, etc.

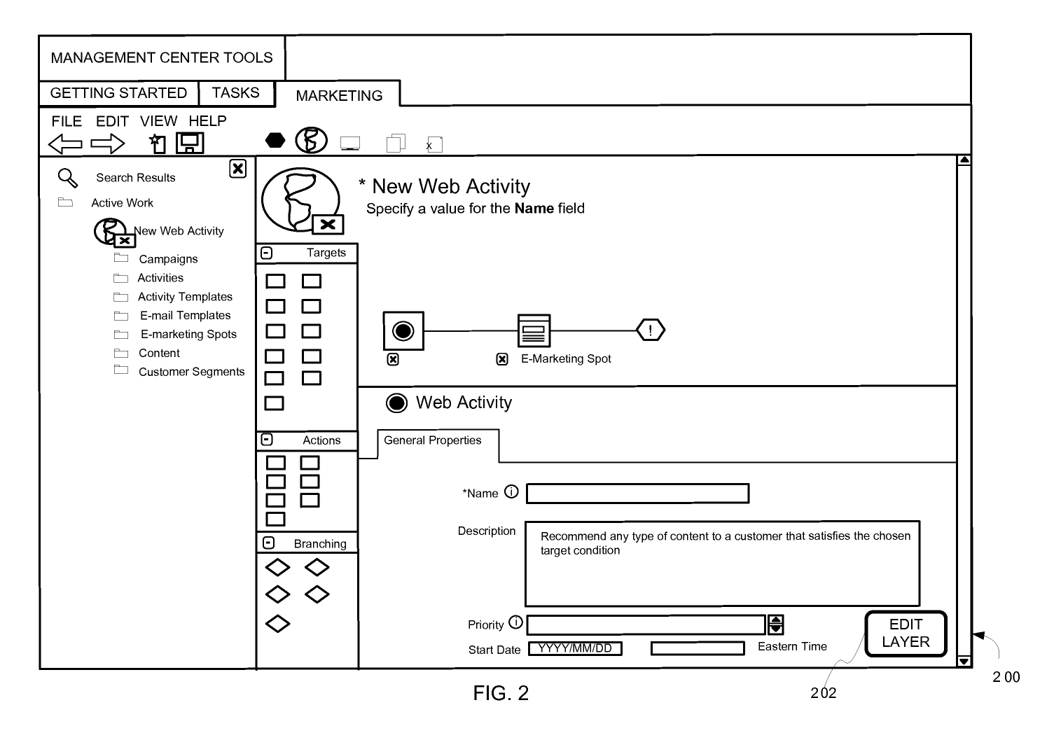

The GUI 122 is shown as being output for display on a monitor 120 of the developer device 102. Also, the GUI 122 includes an edit layer 124 and a review layer 126. The edit layer 124 can be software that is part of the GUI 122 that enables reviewers, developers, etc. to add reviews (e.g., comments, suggestions, etc.) onto the GUI 122. Examples of the edit layer 124 and different types of reviews are described below in reference to FIGS. 2-7. The review layer 126 can be software that is also part of the GUI 122 that enables reviewer, developers, etc. to review the reviews (e.g., comments, suggestions, etc.). For example, a reviewer can review the reviews by other reviewers. This reviewer can then add additional comments to an existing review (e.g., add additional comments, suggestions, etc.), add new reviews, etc. Also, the developer that provided the GUI 122 can use the review layer 126 to review the reviews provided by the different reviewers.

The operations of the system 100 include an operation 130, an operation 132, and an operation 134. In the operation 130, the developer module 110 transmits the GUI 122 (that includes the edit layer 124 and the review layer 126) to the reviewer A device 104. Also, the developer module 110 transmits a review folder 128 with the GUI 122 to the reviewer A device 104. In the operation 132, the developer module 110 transmits the GUI 122 (that includes the edit layer 124 and the review layer 126) and the review folder 128 to the reviewer B device 106. In the operation 134, the developer module 110 transmits the GUI 122 (that includes the edit layer 124 and the review layer 126) and the review folder 128 to the reviewer N device 108.

As further described below, the reviewers can store their reviews in the review folder 128. Subsequently, the reviewers can transmit the review folder back to the developer. Alternatively or in addition to storage in a review folder, the reviewers can transmit their reviews to some backend persistent storage communicatively coupled to the developer device 102, the reviewer A device 104, the reviewer B device 106, and the reviewer N device 108. In this configuration, the reviewer devices can transmit their different reviews to this backend persistent storage. The developer device 102 or other reviewer devices can retrieve the reviews from this backend persistent storage and visually display the reviews with the GUI 122.

Although not shown but has been described above, one reviewer can receive the reviews from other reviewers. For example, after reviewer A has provided reviews, reviewer B and reviewer N can receives those reviews and provide additional reviews to reviewer A's reviews, provide new reviews, etc. Also, while shown as having the GUI 122 being pushed out to the reviewers from the developer device, in some other example embodiments, the developer module 110 can store the GUI 122 in some backend persistent storage, such that the reviewers can download the GUI 122 from this backend persistent storage. Also, the reviewers can review the GUI 122 at least partially concurrent with each other and/or can sequentially review the GUI 122. Also, the reviewers can provide multiple reviews of the GUI 122. For example, reviewer A may review the GUI 122 for a first time and then review the GUI 122 for a second time after reviewer B has provided their review. In some example embodiments, the reviewers and/or the developer can be notified each time a review is completed, the developer has responded to a review, etc.

The reviewer A device 104 includes a monitor 142 and a reviewer module 190. The reviewer device B 106 includes a monitor 144 and a review module 192. The reviewer device N 108 includes a monitor 146 and a review module 192. As shown, the GUI 122 is displayed on the monitor 142 of the reviewer A device 104 to allow reviewer A to visually review the GUI 122. The GUI 122 is also displayed on the monitor 144 of the reviewer B device 104 to allow reviewer B to visually review the GUI 122. The GUI 122 is also displayed on the monitor 146 of the reviewer N device 108 to allow reviewer N to visually review the GUI 122. The reviewer modules 190, 192 and 194 can be software, firmware, hardware or a combination thereof. The reviewer modules 190, 192 and 194 receive the GUI 122 and display the GUI 122 on the monitors 142, 144, and 146. The reviewer modules 190, 192 and 194 also can store and transmit the reviews created by the reviewers. The operations of the reviewer modules 190, 192 and 194 are further described below.

As further described below, the different reviewers can use tools within an edit layer 124 to add reviews (e.g., comments, suggestions, etc.) to the GUI 122. For example, using tools within the edit layer 124, the different reviewers can add markup ink, callouts, text overlays, etc. to the GUI 122. Accordingly, the multiple reviews from multiple reviewers can be viewable on the GUI 122.

In this example, the reviewer A device 104 stores the review folder 128 as a review folder A 114 in some type of machine-readable medium in the reviewer A device 104. The reviewer B device 106 stores the review folder 128 as a review folder B 116 in some type of machine-readable medium in the reviewer B device 106. The reviewer N device 108 stores the review folder 128 as a review folder N 118 in some type of machine-readable medium in the reviewer N device 108. As described above, alternatively or in addition the local storage of the review folders in the reviewer devices, the reviews can be stored in a backend persistent storage. In some example embodiments, the multiple reviews by the multiple reviewers are stored in the review folders that are stored with the GUI 122.

The reviews can be stored in different formats. For example, the reviews can be stored as images, as markup (e.g., Extensible Markup Language (XML) with screen coordinates, control names, etc.), as attributes in source code for particular DOM elements (which can be added on developer side rather than on the review side), etc. The reviews can be stored with different types of metadata. Examples of the different types of metadata include the reviewer name, review date, reviewer discipline (e.g., designer, tester, marketing person, etc.), UI application identification, etc. The UI application identification can include any type of identifier to differentiate among different version of the code (e.g., hash, version number, etc.).

The multiple reviewers can subsequently transmit (e.g., email) the review folders to the developer. In FIG. 1, this is shown by an operation 162, an operation 164, and an operation 166. In the operation 162, the reviewer A device 104 transmits the review folder A 114 to the developer device 102. In the operation 164, the reviewer B device 106 transmits the review folder B 116 to the developer device 102. In the operation 166, the reviewer N device 108 transmits the review folder N 118 to the developer device 102. As shown, upon receipt, the developer module 110 stores the review folder A 114, the review folder B 116, and the review folder N 118 in an application directory 112 that is a directory stored in a machine-readable medium in the developer device 102. The review layer 126 can subsequently retrieve the reviews that are currently stored in the review folders in the application directory 112 for viewing with the GUI 122 on the monitor 120 of the developer device 120. As described above, alternatively or in addition, the developer devices can transmit the reviews to some backend persistent storage (instead of directly to the developer device 102). Accordingly, the review layer 126 can subsequently retrieve the reviews that are currently stored in the review folders in the backend persistent storage for viewing with the GUI 122 on the monitor 120 of the developer device 120. In some example embodiments, the review folders are transmitted from the reviewer devices after the reviewer closes the edit layer, provides an explicit input (e.g., button selection) for transmission, etc. In some example embodiments if the review folders are transmitted to the developer device 102, the developer module 110 can notify other reviewers of the completion of a review by a particular reviewer. In some example embodiments where the review folders are stored in a backend persistent storage, some application associated with the backend persistent storage can notify the developer and/or other reviewers of the completion of the review.

Accordingly, after the developer opens the GUI 122, the review layer 126 loads the reviews from the review folders into the GUI 122. Thus, the developer can view the different reviews from the different reviewers on the GUI 122 being displayed. Similarly, reviewers can view the different reviews from different reviewers on the GUI 122. In some example embodiments, the developer and reviewers can filter the reviews based on reviewer names, date, reviewer discipline, application version, etc. Also, the developer and reviewers can progressively disclose the reviews. For example, the developer and reviewers can progressively disclose metadata or more detailed information on a particular review. In some example embodiments, the developer and reviewers can click through reviews from different reviewers and have the reviews displayed on the GUI 122.

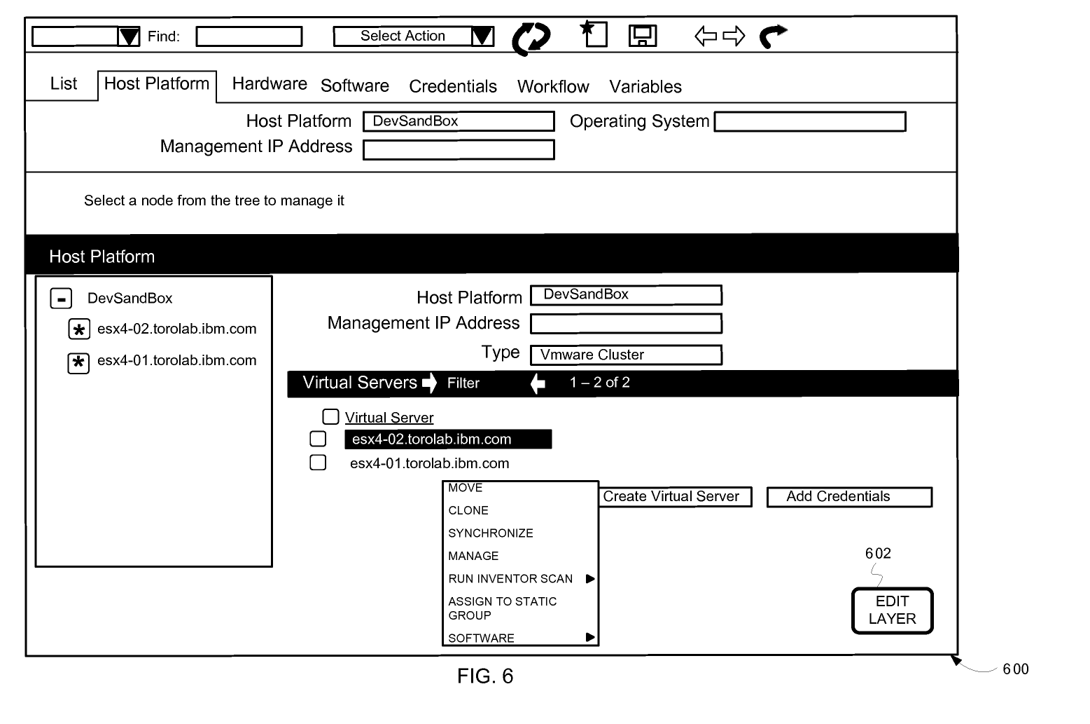

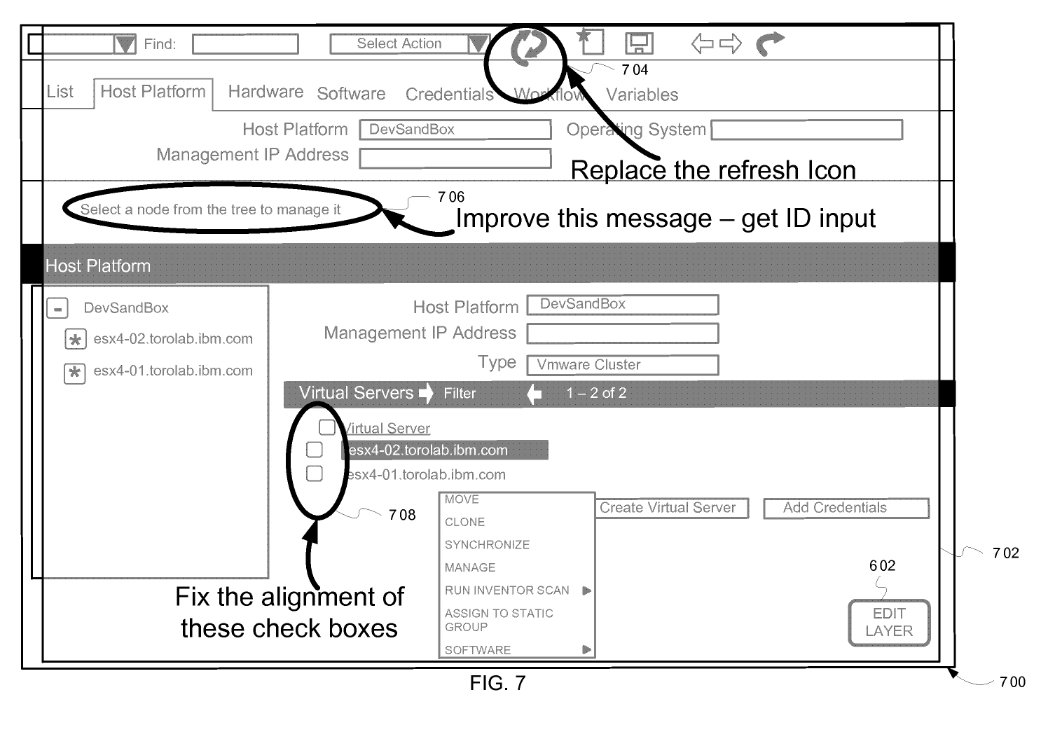

Various example GUIs, according to some example embodiments, are now described. In particular, FIGS. 2-7 depict different example GUIs. FIGS. 2-5 depict a first example GUI at different stages of review. FIGS. 6-7 depict a second example GUI at different stages of review. Where applicable the same reference numbers are used for the same components across different Figures (e.g., 320, 322, 324, 326, etc.).

FIG. 2 depicts an example GUI prior to addition of reviews of the GUI, according to some example embodiments. In particular, FIG. 2 depicts a GUI 200 having various icons, text, panels, etc. The GUI 200 includes a button 202 that activates the edit layer (not shown as activated in FIG. 2). With reference to FIG. 1, the developer can build the GUI 200 (using the developer module 110) to output the GUI 200. The developer can turn on the edit layer as part of the configuration for the build of the GUI 200. Accordingly, when the GUI 200 is displayed the button 202 is overlaid onto the GUI 200 such that the edit layer is activated when the button 202 is selected.

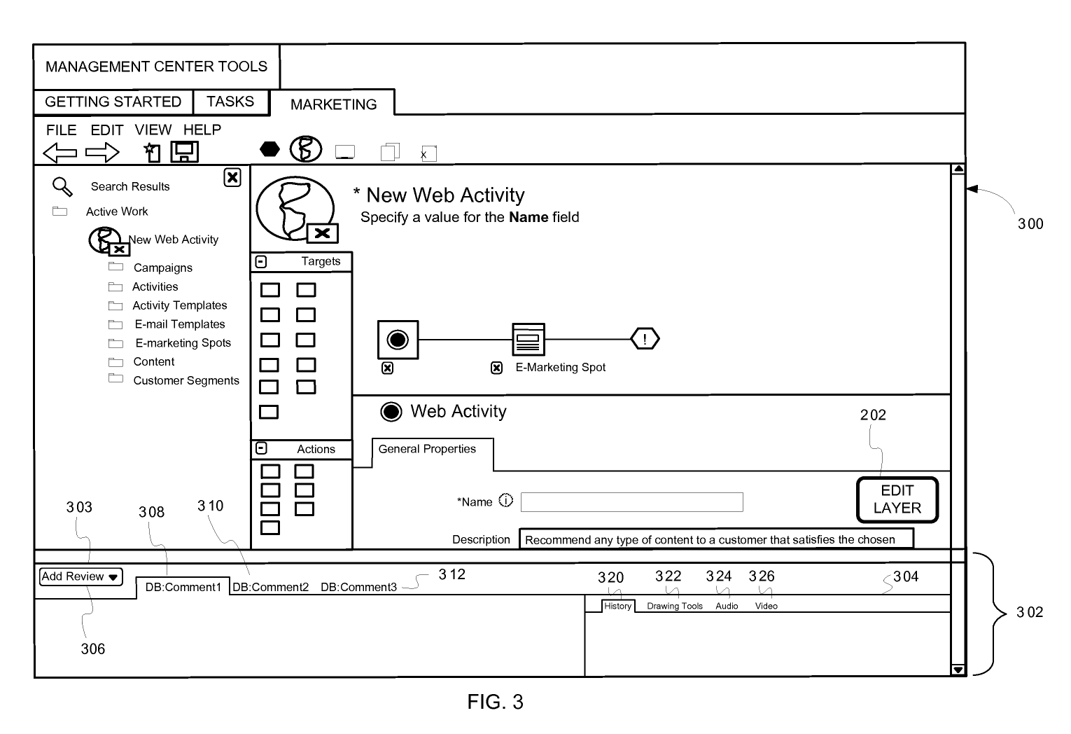

FIG. 3 depicts the example GUI of FIG. 2 wherein an edit layer for adding reviews of the GUI, according to some example embodiments. In particular, FIG. 3 depicts the GUI 200 of FIG. 2 after the button 202 has been selected to activate an edit layer 302 (at the bottom of the GUI 200). The edit layer 302 includes a section 303 and a section 304. The section 303 includes a button 306 to add a new review. The section 303 also includes different tabs for the different reviews added—a review 308, a review 310, and a review 312. If the reviewer selects the button 303, a new tab is added across the top of the section 303—to the right of the tab 312. The currently selected tab is the tab 308. The currently selected tab display information about its associated review (further illustrated below). Accordingly, the developer or reviewer can select the different tabs to view the different reviews. As further described below, the selection of the tab also causes data regarding the associated review to be displayed on the GUI 122.

Also, the currently selected tab in the section 303 affects the data displayed in the section 304. The section 304 includes a history tab 320, a drawing tools tab 322, an audio tab 324, and a video tab 326. The currently selected tab in the section 304 is the history tab 320. Therefore, the developer or reviewer can select the different tabs to view the different data in the different tabs. The data displayed in each of history tab 320, a drawing tools tab 322, an audio tab 324, and a video tab 326 is associated with the review that is associated with the currently selected tab in the section 303. In this example, the data displayed in each of history tab 320, a drawing tools tab 322, an audio tab 324, and a video tab 326 is associated with the review “DB:Comment1”.

The history tab 320 lists various text comments, suggestions, responses, etc. for a given review. The drawing tools tab 322 displays various drawing tools that can be used to markup the GUI 122—shapes, proofreaders' marks, etc. The audio tab 324 displays selectable audio data that can be actual audio regarding the review (e.g., “please swap icon A with icon B on the GUI 122.” Accordingly, the developer or reviewers can select on the audio data to listen to various comments, suggestions, etc. The video tab 326 displays selectable video data that can be actual video regarding the review. For example, a reviewer can add video of another GUI, its movements has buttons are selected, etc. Such video can assist the developer in understanding what changes are being requested by a given reviewer. Thus, a reviewer can provide any combination of text, audio, video, actual drawing on the GUI 122 for a given review.

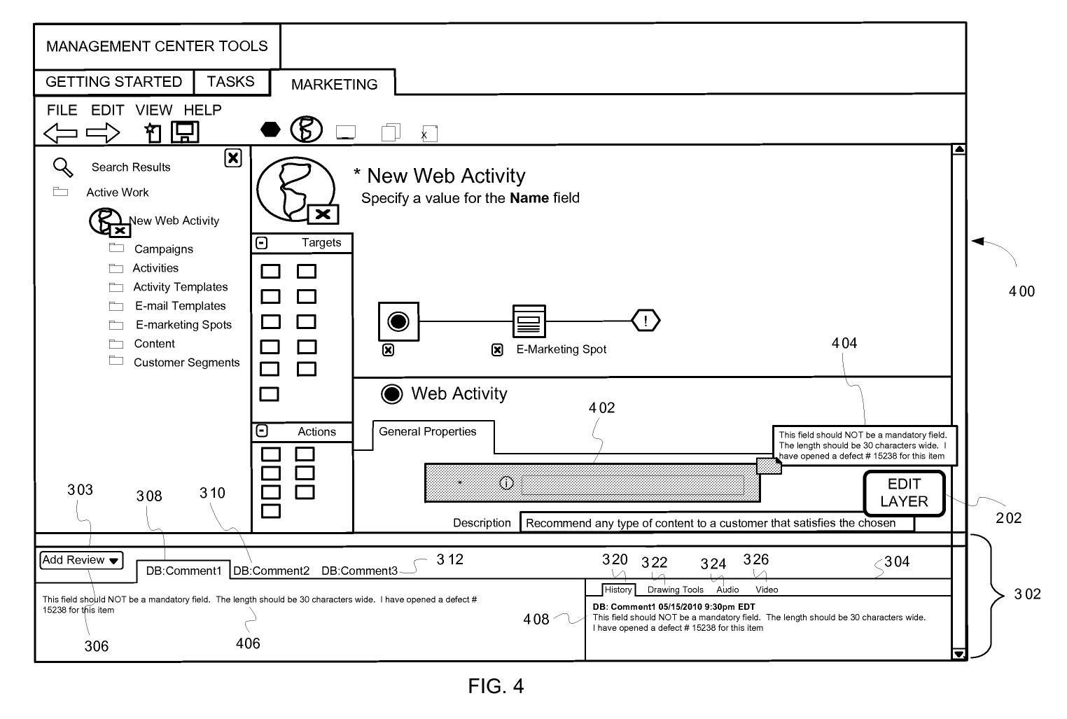

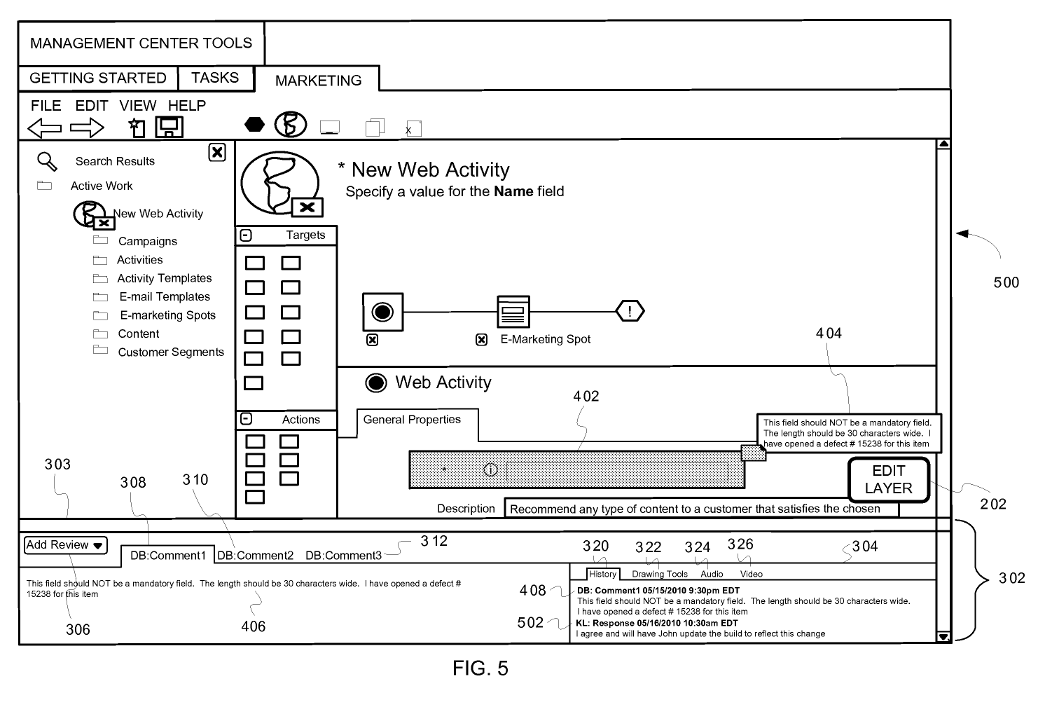

FIG. 4 depicts the example GUI of FIG. 3 wherein a review has been added using the edit layer, according to some example embodiments. In particular, FIG. 4 depicts the GUI 300 of FIG. 3 after a review has been added—a GUI 400. A comment has been overlaid onto the GUI 400. In particular, the name field has been highlighted—see 402 and a text box 404 has been added for this highlighted section. The text box 404 includes a comment—“This field should NOT be a mandatory field. The length should be 30 characters wide. I have opened a defect #15238 for this item.” This same text has been duplicated in the edit layer 302 in the tab 308—see 406. Accordingly, as the developer or reviewer reviews the comments by selecting the different tabs in the edit layer 302, the associated reviews that have been overlaid onto the GUI 400 are shown. Also, the history tab 320 in the edit layer 302 includes a history of comments for this given review. In this example, there is only one comment (408), which is a duplication of the text at 404 and 406. If other reviewers or the developer add comments regarding this review, these comments are tracked in the history tab 320. See example in FIG. 5 below.

FIG. 5 depicts the example GUI of FIG. 4 wherein a response to the review has been added using the edit layer, according to some example embodiments. In particular, FIG. 5 depicts the GUI 400 of FIG. 4 after a comment from the developer has been added to an existing review—a GUI 500. A comment 502 has been made regarding an existing review (see 402, 404, and 406). In this example, the comment 502 is made by the developer. The comment 502 is shown in the history tab 320—“I agree and will have John update the build to reflect this change.” In some example embodiments, the developer or other reviewers can provide comments about an existing review by selecting the existing review on the GUI 122 (the area at 402 or 404). In response, a text window can be provided to enable the developer or other reviewers to add the comments. As shown, these comments to an existing review can be shown in the edit layer 302 in the history tab 320. In some example embodiments, each time a review or additional comments about a review are added to the GUI, the developer and reviewers can be notified about the change. Alternatively or in addition, the additional reviews or comments can be pushed out to the developer device and the reviewer devices. While described as providing a text comment, the developer or other reviewers can also provide video, audio or overlay additional data onto the GUI 122 regarding an existing review.

FIG. 6 depicts a different example GUI prior to addition of reviews of the GUI, according to some example embodiments. In particular, FIG. 6 depicts a GUI 600 having various icons, text, panels, etc. The GUI 200 includes a button 602 that activates the edit layer (not shown as activated in FIG. 6). With reference to FIG. 1, the developer can build the GUI 600 (using the developer module 110) to output the GUI 600. The developer can turn on the edit layer as part of the configuration for the build of the GUI 600. Accordingly, when the GUI 600 is displayed the button 602 is overlaid onto the GUI 600 such that the edit layer is activated when the button 602 is selected.

FIG. 7 depicts the example GUI of FIG. 6 after the addition of multiple reviews, according to some example embodiments. In particular, FIG. 7 depicts a GUI 600 after an edit overlay layer 702 has been overlaid onto the GUI—a GUI 700. In this example, multiple reviews from one or more reviewers can be viewed together on the edit overlay layer 702. This edit overlay layer 702 can provide a combined feedback from multiple reviewers, all in a same context. This configuration can be especially useful if there are conflicting reviews from different reviewers. For example, reviewer A provides a review to change the text on the GUI 700 to indicate “X”, while reviewer B provides a review to change the same text on the GUI 700 to indicate “Y”. As shown, the edit overlay layer 702 includes three reviews—a review 704, a review 706, and a review 708. The review 704 provides an instruction to replace the refresh icon. The review 706 provides an instruction to modify a text message. The review 708 provides an instruction to correct the alignment of check boxes. After activating the edit overlay layer 702, a reviewer can add a review by selecting a portion of the GUI 700 (creating the oval over the selected portion). The edit overlay layer 702 can then present a text box to the reviewer to enable the reviewer to add their review. In some example embodiments, a developer or other reviewer can provide additional comments to an existing review—similar to the operation described in reference to FIG. 5. These additional comments can be adding by selecting an existing review. In response, the edit overlay layer 702 provides a text box to add the comment. These multiple comment can be shown along with the comments for the existing review.

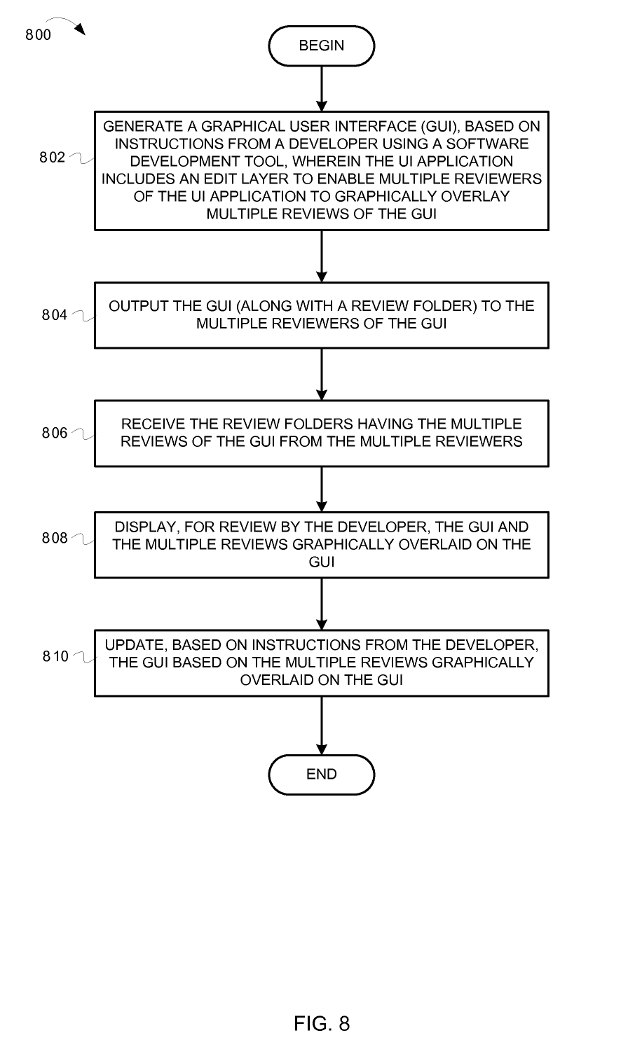

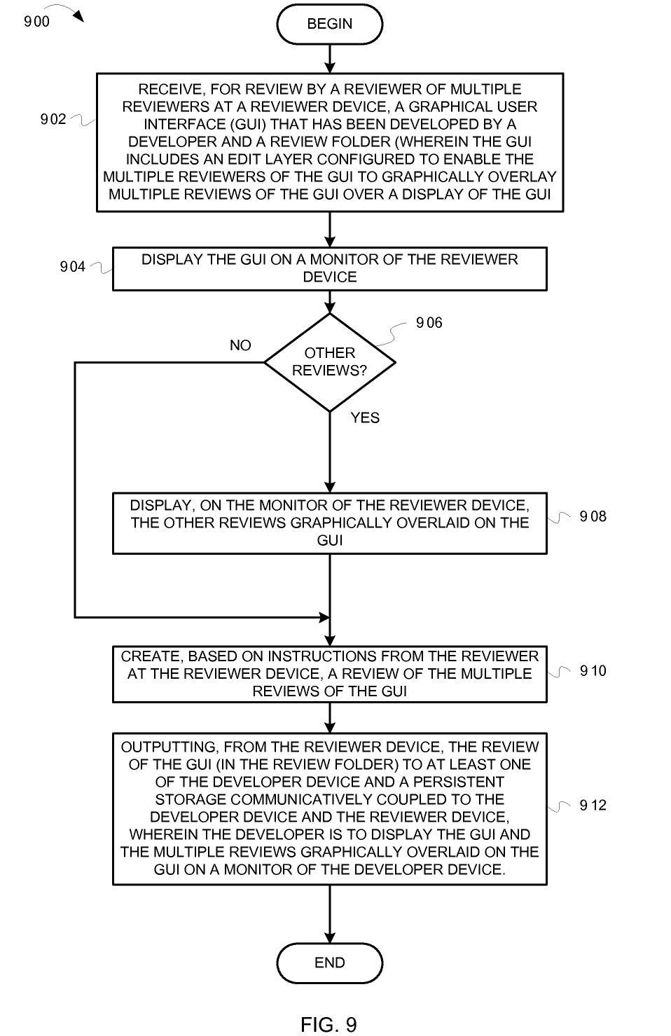

Flowcharts of operations, according to some example embodiments, are now described. FIG. 8 depicts a first flowchart from the perspective of the developer device and performed by the developer module 110 (see FIG. 1). FIG. 9 depicts a second flowchart from the perspective of the reviewer device and performed by one of the reviewer modules 190, 192, and 194. The operations of the flowcharts are described with reference to FIGS. 1-7.

FIG. 8 depicts a flowchart for creating and outputting a GUI for enable multiple reviews of the GUI, according to some example embodiments. The operations of a flowchart 800 of FIG. 8 start at block 802.

At block 802, the developer module 110 generates a GUI, based on instructions from a developer using a software development tool, wherein the GUI includes an edit layer to enable multiple reviewers of the GUI application to graphically overlay multiple reviews of the GUI. With reference to FIG. 1, the developer module 110 executing on the developer device 102 can create the GUI 122. The developer module 110 can integrate the edit layer 124 and the review layer 126 into the GUI 122. The edit layer 124 is created so that multiple reviewers can mark up the design, layout, words, etc. of the GUI 122, using shapes, proofreaders' marks, etc. Accordingly, the development process can be more efficient. The developers can simply turn on the edit layer 124 and the review layer 126 for the GUI 122 before sending the GUI to the appropriate reviewers. The developer can activate the edit layer 124 in some type of configuration file for the GUI 122. The edit layer 124 can be a GUI container that has some editing controls. Accordingly, when the GUI 122 is built, the edit layer 124 can be used instead of normal UI containers. The edit layer 124 can be implemented using any type of applications that enables the reviews to be integrated with the visual output of the GUI 122. Example applications that can implement the edit layer 124 include Standard Widget Toolkit (SWT) shell, HyperText Markup Language (HTML) DIV, etc. The edit layer 124 includes controls to add a general comment, add a comment to a particular spot in the UI application, draw a figure, screen capture, motion capture, Document Object Model (DOM) selections for more precise commenting, audio notes, etc. The review layer 126 is created to enable the developer and reviewer to review the reviews provided by reviewers. Operations of the flowchart 800 continue at block 804.

At block 804, the developer module 110 outputs the GUI (along with a review folder) to the multiple reviewers of the GUI. With reference to FIG. 1, the developer module 110 outputs the GUI 122 (including the edit layer 124 and the review layer 126) along with the review folder 128 to the reviewer A device 104, the reviewer B device 106, and the reviewer N device 108. Accordingly, any or all of the reviewer A, the reviewer N, and the reviewer N can add reviews (e.g., comments, suggestions, etc.) to the GUI 122. While described such that the developer module 110 directly outputs the GUI 122 to the reviewer devices, in some other example embodiments the developer module 110 can store the GUI in a local or remote persistent storage for subsequent access by the reviewers. For example, the reviewers can be notified of the availability of the GUI 122 for its review. The reviewers can then download the GUI 122 at some later time. Operations of the flowchart 800 continue at block 806.

At block 806, the developer module 110 receives the review folders having the multiple reviews of the GUI from the multiple reviewers. With reference to FIG. 1, the developer module 110 receives the review folder A 114 from the reviewer A device 104 (shown as the operation 162); receives the review folder B 116 from the reviewer B device 106 (shown as the operation 164); and receives the review folder N 118 from the reviewer N device 108. The creation of the reviews and storage in the review folders by the reviewer devices is described below in reference to the flowchart 900 of FIG. 9. The different reviews can include added reviews and comments or suggestions added to an existing review. As further described below, different reviewers can use tools within the edit layer 124 of the GUI 123 to add reviews (e.g., comments, suggestions, etc.) to the GUI 122. For example, using tools within the edit layer 124, the different reviewers can add markup ink, callouts, text overlays, etc. to the GUI 122. Accordingly, the multiple reviews from multiple reviewers can be viewable on the GUI 122—see examples in FIGS. 2-7. Operations of the flowchart 800 continue at block 808.

At block 808, the developer module 110 displays, for review by the developer, the GUI and the multiple reviews graphically overlaid on the GUI. With reference to FIG. 1, the developer module 110 displays the GUI 122 on the monitor 120 of the developer device 102. The developer module 110 can activate the review layer 126 to review the different reviews from the different reviewers—see examples in FIGS. 2-7. Operations of the flowchart 800 continue at block 810.

At block 810, the developer module 110 updates, based on instructions from the developer, the GUI based on the multiple reviews graphically overlaid on the GUI. In particular, the developer can update, through the developer module 110, the GUI 122 based on the different reviews, can add comments to the reviews, etc. The developer can create a new version of the GUI 122 and then redistribute the new version of the GUI 122 to the reviewers for another round of reviews. Operations of the flowchart 800 are complete.

FIG. 9 depicts a flowchart for providing a review of multiple reviews of a GUI, according to some example embodiments. The operations of the flowchart 900 are described in reference to being executed by the reviewer module 190 in the reviewer A device 104. Similar operations can be performed by the reviewer module 192 in the reviewer B device 106 and the reviewer module 194 in the reviewer N device 108. The operations of the flowchart 900 of FIG. 9 start at block 902.

At block 902, the reviewer module 190 receives, for review by a reviewer of multiple reviewers at a reviewer device, a GUI that has been developed by a developer and a review folder. With reference to FIG. 1, the reviewer module 190 receives the GUI 122 from the developer device 102. Alternatively or in addition as described above, the reviewer module 190 can receive notification of a GUI that is available for review. The reviewer module 190 can then download the GUI 122 from some persistent storage. Also, the GUI 122 includes the edit layer 124 to allow the reviewer to add a new review. The GUI also includes the review layer 126 to allow the reviewer to review existing reviews and to add comments to these existing reviews. Operations of the flowchart 900 continue at block 904.

At block 904, the reviewer module 190 displays the GUI on a monitor of the reviewer device. With reference to FIG. 1, the reviewer module 190 displays the GUI 122 on the monitor 142 of the reviewer A device 104. Operations of the flowchart 900 continue at block 906.

At block 906, the reviewer module 190 determines whether there are existing reviews of the GUI. With reference to FIG. 1, the reviewer module 190 determines whether other reviewers have already provided reviews of the GUI 122. In some example embodiments, the existing reviews can be included in the review folder that is provided along with the GUI 122. If there are existing reviews of the GUI 122, operations of the flowchart 900 continue at block 908. Otherwise, the operations of the flowchart 900 continue at block 912.

At block 908, the reviewer module 190 displays, on the monitor of the reviewer device, the other reviews graphically overlaid on the GUI. With reference to FIG. 1, the reviewer module 190 displays, on the monitor 142 of the reviewer A device 104, the other reviews graphically overlaid on the GUI 122—see examples in FIGS. 2-7. Operations of the flowchart 900 continue at block 910.

At block 910, the reviewer module 190 creates, based on instructions from the reviewer at the reviewer device, a review of the multiple reviews of the GUI. With reference to FIG. 1, the reviewer module 190 creates, based on instructions from the reviewer at the reviewer A device 104, a review of the GUI 122. Alternatively or in addition, the reviewer module 190 can create, based on instructions from the reviewer at the reviewer A device 104, comments, suggestions, responses, etc. to an existing review of the GUI 122. In some example embodiments, the reviews are stored in review folders that are stored with the GUI 122—the review folder A 114. Alternatively or in addition, the multiple reviews can be stored in a persistent storage on a backend server, on the developer device, etc. The reviews can be stored in different formats. For example, the reviews can be stored as images, as markup (e.g., Extensible Markup Language (XML) with screen coordinates, control names, etc.), as attributes in source code for particular DOM elements (which can be added on developer side rather than on the review side), etc. The reviews can be stored with different types of metadata. Examples of the different types of metadata include the reviewer name, review date, reviewer discipline (e.g., designer, tester, marketing person, etc.), GUI identification, etc. The GUI identification can include any type of identifier to differentiate among different version of the code (e.g., hash, version number, etc.). Operations of the flowchart 900 continue at block 912.

At block 912, the reviewer module 190 outputs, from the reviewer device, the review of the GUI (in the review folder) to at least one of the developer device and a persistent storage communicatively coupled to the developer device and the reviewer device. With reference to FIG. 1, the reviewer module 190 can output the review folder A 114 that includes the reviews to the developer device 102—see the operation 162. Alternatively or in addition, the reviewer module 190 can output the review folder A 114 to some backend storage device on the network that is communicatively coupled to the reviewer A device 104 and the developer device 102. Accordingly, the developer module 110 can subsequently download the review folder A 114 such that the reviews are graphically overlaid onto the GUI 122. Operations of the flowchart 800 are complete.

Accordingly, as described, a GUI includes an editing layer that is integrated into the development stream of the GUI. This edit layer allows multiple reviewers to markup the design, layout, words, etc. using shapes, proofreader's marks, etc. Such a configuration enables the developer and the reviewers to easily review the multiple reviews from the reviewers. This configuration allows the development process to be more efficient.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 10 depicts an example computer system. A computer system includes processor unit 1001 (possibly including multiple processors, multiple cores, multiple nodes, and/or implementing multi-threading, etc.). The computer system includes memory 1007. Memory 1007 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes bus 1003 (e.g., PCI, ISA, PCI-Express, HyperTransport®, InfiniBand®, NuBus, etc.), network interface 1005 (e.g., an ATM interface, an Ethernet interface, a Frame Relay interface, SONET interface, wireless interface, etc.), and storage device(s) 1009 (e.g., optical storage, magnetic storage, etc.). The computer system also comprises a developer module 1040 and a reviewer module 1042. In some example embodiments, the computer system 1000 comprises one or the other. For example, if the computer system is representative of the developer device 102 of FIG. 1, the computer system includes the developer module 1040. In such a configuration, the developer module 1040 can perform the operations described in reference to FIG. 8. If the computer system is representative of one of the reviewer devices 104, 106 or 108 of FIG. 1, the computer system includes the reviewer module 1042. In such a configuration, the developer module 1042 can perform the operations described in reference to FIG. 9. Any one of these functionalities may be partially (or entirely) implemented in hardware and/or on processing unit 1001. For example, the functionality may be implemented with an application specific integrated circuit, in logic implemented in processing unit 1001, in a co-processor on a peripheral device or card, etc. Further, realizations may include fewer or additional components not illustrated in FIG. 10 (e.g., video cards, audio cards, additional network interfaces, peripheral devices, etc.). The processor unit 1001, storage device(s) 1009, and network interface 1005 are coupled to bus 1003. Although illustrated as being coupled to bus 1003, memory 1007 may be coupled to processor unit 1001.

While the embodiments are described with reference to various implementations and exploitations, it will be understood that these embodiments are illustrative and that the scope of the inventive subject matter is not limited to them. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
generating a User Interface (UI) application, based on instructions from a developer using a software development tool, the UI application having an edit layer configured to enable multiple reviewers of the UI application to graphically overlay multiple reviews of the UI application over a display of the UI application, wherein the multiple reviews comprise a markup of at least one of a design, a layout and a wording of text of the UI application;
outputting the UI application to the multiple reviewers of the UI application;
receiving the multiple reviews of the UI application from the multiple reviewers; and
displaying, for review by the developer, the UI application and the multiple reviews graphically overlaid on the UI application.

2. The method of claim 1, further comprising outputting a review folder with the UI application to the multiple reviewers of the UI application, wherein the multiple reviews are stored in the review folder, wherein receiving the multiple reviews of the UI application comprises receiving the review folder from the multiple reviewers.

3. The method of claim 1, wherein generating the UI application is performed by the developer at a developer device, wherein outputting the UI application to the multiple reviewers comprises outputting the UI application to multiple reviewer devices used by the multiple reviewers to create the multiple reviews, wherein the developer device and the multiple reviewer devices are communicatively coupled together.

4. The method of claim 3,
wherein the multiple reviews are stored, from the multiple reviewer devices, in a persistent storage that is communicatively coupled to the developer device and the multiple reviewer devices; and
wherein the method comprises retrieving the multiple reviews from the persistent storage for displaying the UI application and the multiple reviews graphically overlaid on the UI application.

5. The method of claim 1, wherein the multiple reviewers comprises at least one of a designer of the UI application, a developer of a different UI application, and a tester of the UI application.

6. A method comprising:
receiving, for review by a reviewer of multiple reviewers at a reviewer device, a Graphical User Interface (GUI) that has been developed by a developer on a developer device using a software development tool, the GUI having an edit layer configured to enable the multiple reviewers of the GUI to graphically overlay multiple reviews of the GUI over a display of the GUI;
displaying the GUI on a monitor of the reviewer device;
creating, based on instructions from the reviewer at the reviewer device, a review of the multiple reviews of the GUI, wherein the review comprises at least one of a graphically markup of a design of the GUI, a graphically markup of a layout of the GUI, a graphically markup of a wording of text of the GUI, a selectable link in the edit layer for displaying a video regarding the review, and a selectable link in the edit layer for audio regarding the review; and
outputting, from the reviewer device, the review of the GUI to at least one of the developer device and a persistent storage communicatively coupled to the developer device and the reviewer device, wherein the developer is to display the GUI and the multiple reviews graphically overlaid on the GUI on a monitor of the developer device.

7. The method of claim 6, further comprising
receiving, at the reviewer device, other reviews of the multiple reviews of the GUI by other reviewers; and
displaying, on the monitor of the reviewer device, the other reviews graphically overlaid on the GUI.

8. The method of claim 6, wherein the multiple reviewers comprises at least one of a designer of the GUI, a developer of a different GUI application, and a tester of the GUI.

9. The method of claim 6, further comprising
receiving, by the reviewer of the multiple reviewers at the reviewer device, a review folder with the GUI; and
wherein outputting the review of the GUI comprises outputting the review folder that includes the review to the at least one of the developer device or the persistent storage.

10. The method of claim 6, wherein creating the review comprises storing metadata with the review, wherein the metadata comprises at least one of a reviewer name, review date, reviewer discipline, and GUI identification.

11. A computer program product for reviewing a User Interface (UI) application, the computer program product comprising:
a computer readable storage medium having computer usable program code embodied therewith, the computer usable program code comprising a computer usable program code configured to:
generate the UI application, based on instructions from a developer using a software development tool, the UI application having an edit layer configured to enable multiple reviewers of the UI application to graphically overlay multiple reviews of the UI application over a display of the UI application, wherein the multiple reviews comprise a markup of at least one of a design, a layout and a wording of text of the UI application;
output the UI application to the multiple reviewers of the UI application;
receive the multiple reviews of the UI application from the multiple reviewers; and
display, for view by the developer, the UI application and the multiple reviews graphically overlaid on the UI application.

12. The computer program product of claim 11, wherein the computer usable program code is configured to output a review folder with the UI application to the multiple reviewers of the UI application, wherein the multiple reviews are stored in the review folder, wherein receipt of the multiple reviews of the UI application comprises receipt of the review folder from the multiple reviewers.

13. The computer program product of claim 11, wherein the computer usable program code is configured to execute on a developer device, wherein the computer usable program code is configured to output the UI application to multiple reviewer devices used by the multiple reviewers to create the multiple reviews, wherein the developer device and the multiple reviewer devices are communicatively coupled together.

14. The computer program product of claim 13,
wherein the multiple reviews are stored, from the multiple reviewer devices, in a persistent storage that is communicatively coupled to the developer device and the multiple reviewer devices; and
wherein the computer usable program code is configured to retrieve the multiple reviews from the persistent storage for display of the UI application and the multiple reviews graphically overlaid on the UI application.

15. The computer program product of claim 11, wherein the multiple reviewers comprises at least one of a designer of the UI application, a developer of a different UI application, and a tester of the UI application.

16. An apparatus comprising:
a monitor;
a machine-readable medium;
a processor;
a reviewer module operable to execute on the processor, the reviewer module configured to
receive a Graphical User Interface (GUI) that has been developed by a developer on a developer device using a software development tool, the GUI received for review by a reviewer of multiple reviewers of the GUI, the GUI having an edit layer configured to enable the multiple reviewers of the GUI to graphically overlay multiple reviews of the GUI over a display of the GUI, wherein execution of the instructions are configured to store the GUI in the machine-readable medium;
create, based on instructions from the reviewer, a review of the multiple reviews of the GUI, wherein the review comprises at least one of a graphically markup of a design of the GUI, a graphically markup of a layout of the GUI, a graphically markup of a wording of text of the GUI, a selectable link in the edit layer for displaying a video regarding the review, and a selectable link in the edit layer for audio regarding the review; and
output the review of the GUI to at least one of the developer device and a persistent storage communicatively coupled to the developer device and the apparatus, wherein the developer is to display the GUI and the multiple reviews graphically overlaid on the GUI on a monitor of the developer device.

17. The apparatus of claim 16, wherein the reviewer module is configured to,
receive other reviews of the multiple reviews of the GUI by other reviewers; and
display, on the monitor, the other reviews graphically overlaid on the GUI.

18. The apparatus of claim 16, wherein the multiple reviewers comprises at least one of a designer of the GUI, a developer of a different GUI application, and a tester of the GUI.

19. The apparatus of claim 16, wherein the reviewer module is configured to,
receive a review folder with the GUI; and
output the review folder that includes the review to the at least one of the developer device and the persistent storage.

20. The apparatus of claim 16, wherein the reviewer module is configured to store metadata with the review, wherein the metadata comprises at least one of a reviewer name, review date, reviewer discipline, and GUI identification.
